(19) United States
(12) Patent Application Publication
(10) Pub. No.: US 2006/0256025 A1
(43) Pub. Date: Nov. 16, 2006

(54) Machine Producible Directive Closed-Loop Impulse Antenna

(75) Inventors: Bernt Askild Askildsen, Rapid City, SD (US); Scott Randall Thompson, Hermosa, SD (US)

Correspondence Address: Scott Thompson;RealTronics Corporation, 322 Canal Street, Rapid City, SD, 57701-2680, US

(73) Assignee: REALTRONICS CORPORATION, Rapid City, SD (US)

(21) Appl. No.: 10/908,497

(22) Filed: May 13, 2005

(51) Int. Cl. H01Q 9/28

(52) U.S. Cl. 343/807; 343/793

(57) ABSTRACT

A low-cost high performance ultra wideband antenna that can be machine replicated is disclosed. The apparatus includes an inner closed-loop broadband antenna circuit that may be comprised of single or multiple conductive sheets that are electrically connected by conductive or impedance tapered regions that are positioned in an area that does not interfere or interferes minimally with antenna performance. Two continuous sheets of dielectric material cover the back reflector shield area, which leaves only the antenna elements exposed. The dielectric materials are subsequently enclosed by inner and outer conductive shields that are electrically connected to common ground and side shields that may be used to improve directivity. The closed-loop broadband antenna circuit and the feed-point connections may be grounded by a separate path within the device. The resulting stack of materials is easily machine assembled into an antenna apparatus by employing stamping, folding, injection, or other methods.

### CROSS-REFERENCE TO RELATED APPLICATIONS

Current US Class: 343/793, 343/807, 343/845

International Class: HO1Q 001/38, 48

Field of Search: 250/216, 342/379, 343/727, 730, 739, 740, 775, 777, 793, 795, 807, 813, 814, 815, 819, 820, 826, 828, 841, 845, 912, 913

### OTHER PUBLICATIONS

[1] R. L. Carrel, “The characteristic impedance of two infinite cones of arbitrary cross section,” IEEE Trans. Antennas Propagation, vol. AP-6, no. 2, pp. 197-201, 1958.

[2] T. T. Wu and R. W. P. King, “The Cylindrical Antenna with Nonreflecting Resistive Loading”, IEEE Transactions on Antennas and Propagation, vol. AP-13, No. 3, pp. 369-373, May 1965.

[3] Shen, “An Experimental Study of the Antenna with Nonreflecting Resistive Loading”, IEEE Transactions on Antennas and Propagation, vol. AP15, No. 5, September 1967, pp. 606-611.

[4] Clapp, “A Resistively Loaded, Printed Circuit, Electrically Short Dipole Element for Wideband Array Applications”, IEEE, May 1993, pp. 478-481

[5] K. L. Shiager, G. S. Smith and J. G. Maloney, “Optimization of bow-tie antennas for pulse radiation,” IEEE Trans. Antennas Propagation, vol. 42, no. 7, pp. 975-982, 1994.

[6] Amert, T., Wolf, J., Albers, L., Palecek, D., Thompson, S., Askildsen, B., Whites, K. W., “Economical Resistive Tapering of Bowtie Antennas,” IEEE Antennas and Propagation Society Symposium, ISIU RSM, Monterey, Calif., Page(s): 1772-1775, Jun. 20-25, 2004

[7] Johnson, R. C., “Shielded-Loop Antenna”, Antenna Engineering Handbook, Third Edition, McGraw-Hill, ISBN 0-07-032381-X, p. 5-19, 1993

[8] Thompson, S., Askildsen, B., “Optimal Tapered Band Positioning to Mitigate Flare-End Ringing of Broadband Antennas,” U.S. patent application Ser. No. 10/906,997, Mar. 15, 2005.

### STATEMENT REGARDING FEDERALLY SPONSORED RESEARCH OR DEVELOPMENT

None.

Reference to Sequence Listing, a Table, or a Computer Program Appendix

None.

### BACKGROUND OF THE INVENTION

The challenge of specifying an optimal antenna geometry that supports a broad range of wavelengths is generally afforded at the expense of antenna ringing, polarization offsets, parasitic side-lobe generation, radiation efficiency or any combination thereof. End-fire or flare-end ringing occurs when a signal bounces back-and-forth between the feed-point and the flare end of an antenna. This is a particularly prominent problem for ultra-wideband antennas such as that described in U.S. Pat. Nos. 3,369,245 and 3,984,838 and by Carrel in [1].

A primary challenge of antenna design is to mitigate the forgoing problems without distorting the rising edge of the transmitted pulse or destabilizing the ultra wideband impedance characteristics of the antenna. Prior art employed combinations of flair end lump loading and impedance tapering to suppress end-fire ringing at the cost of rising edge distortion and poor radiation efficiency; see [2], and U.S. Pat. No. 4,679,007.

The quest for broadband antennas that are capable of effectively transmitting impulse signals or multiple carrier waves has been ongoing for nearly a half-century and is documented through prior art and public disclosure including the dipole antenna, U.S. Pat. No. 4,125,840; resistive loaded and tapered antennas, [3] and U.S. Pat. Nos. 4,642,645 and 4,803,495; printed circuit board antennas, [4] and U.S. Pat. No. 4,758,843; side-lobe suppression antennas, U.S. Pat. No. 4,376,940; and lump loading for maximal energy transfer, U.S. Pat. No. 4,679,007.

Lump loading alone does not mitigate the problem of end-fire ringing during the first several cycles and consequently target detection applications are impeded at close range. Tapered antennas address the problem of close range target detection very effectively by distributing bands of impedance across the antenna to convert the ringing energy into heat. However, this payoff is afforded at the expense of a substantial drop in radiation efficiency and an accompanying requirement for more powerful transmitter hardware. Moreover, the discrete interface at each tapered band creates parasitic side-lobes and induces reflections near the feed point that distorts the rising edge of the transmitted pulse. This is a particularly prominent problem for target identification systems because the rising edge of the pulse is used to induce reflections that carry sufficient spectral bandwidth to characterize the target. These reflections are only useful if the transmitted signal has very low levels of distortion.

More recent work by Shlager, Smith and Maloney partially addressed the problem by applying a resistive taper to bowtie antennas [5]. The devices were implemented by constructing bow-tie antenna leaves from three sections of material that were comprised of varying conductivities that followed the tapering guidelines in [2]. A continued effort by Askildsen, Thompson, Whites, et al. in 2004 expanded the applicability of resistive tapering for high-performance ultra wide band bow-tie antennas in [4]. These efforts further revealed that resistive tapering reduces the return signal of an ultra wideband (UWB) signal pulse.

Several recent designs were patented to address the deficiencies of the above listed prior art including a low side-lobe resistive reflector antenna, U.S. Pat. No. 5,134,423; a low profile antenna, U.S. Pat. No. 5,184,143; a top loaded Bow-Tie antenna, U.S. Pat. No. 6,323,821; a closely coupled directive antenna, U.S. Pat. No. 6,025,811; a tapered, folded monopole antenna, U.S. Pat. No. 6,774,858; and optimal tapered band positioning to mitigate flare-end ringing of broadband antennas, U.S. patent application Ser. No. 10/906,997 (pending) [8]. Each of these prior disclosures employed unique methods to mitigate known problems of the expired patents that were described earlier, yet none fully and simultaneously address the problems of end-fire ringing, consistent impedance characteristics, the rising edge distortion on the transmitted pulse, parasitic side lobe generation, non-uniform polarization artifacts, radiation efficiency, or any combination thereof.

While prior art does substantially improve select antenna parameters, these methods introduce new design tradeoffs that interfere with antenna performance. This invention applies a novel approach that leverages on the principles of shielded closed loop antennas [7], ultra wide band antenna design techniques, and impedance tapering to devise an impulse antenna that mitigates the foregoing. The invention simultaneously provides efficient canceling for balanced oppositely polarized signals and safe dissipation for unbalanced signal energy. This disclosure further describes a low-cost high-tolerance method of manufacturing tapered broadband antennas without incurring the expense of significant performance tradeoffs.

### BRIEF SUMMARY OF THE INVENTION

This invention describes a novel antenna and reflector apparatus that uses continuous sheets of conductive and dielectric materials to construct the device. Any tapered loading components are placed in an area of the antenna loop circuit that is enclosed by the reflector shields. The antenna loop circuit is sandwiched between two dielectric layers that are enclosed by conductive shields. The complete assembly resembles a shielded loop antenna that is typically used for continuous wave emissions; however the device is comprised of geometries that support high performance ultra-wideband dipole transmission.

### BRIEF DESCRIPTION OF SEVERAL VIEWS OF THE DRAWINGS

Electric equivalent circuits of the disclosed invention are illustrated in FIGS. 1 and 2. The disclosed invention is graphically depicted in the form of a bow-tie antenna in FIGS. 3 through 12 to illustrate the invention. However, these figures are not intended to restrict the scope of this invention to bow-tie antennas.

FIG. 1: Is an equivalent circuit for ungrounded cancellation.

FIG. 2: Is an equivalent circuit for grounded cancellation.

FIG. 3: Displays the functional layers of the antenna apparatus.

FIG. 4: Is the closed loop antenna circuit.

FIG. 5: Is an expanded view of the device components.

FIG. 6: Displays the stacked components and the two first folds.

FIG. 7: Displays the downward bend of the side shields.

FIG. 8: Displays the first downward bend of the component layers.

FIG. 9: Displays the second downward bend of the component layers.

FIG. 10: Displays a prospective top view of the assembled device.

FIG. 11: Displays a prospective bottom view of the assembled device.

FIG. 12: Displays an alternative embodiment of the device.

### DETAILED DESCRIPTION OF THE INVENTION

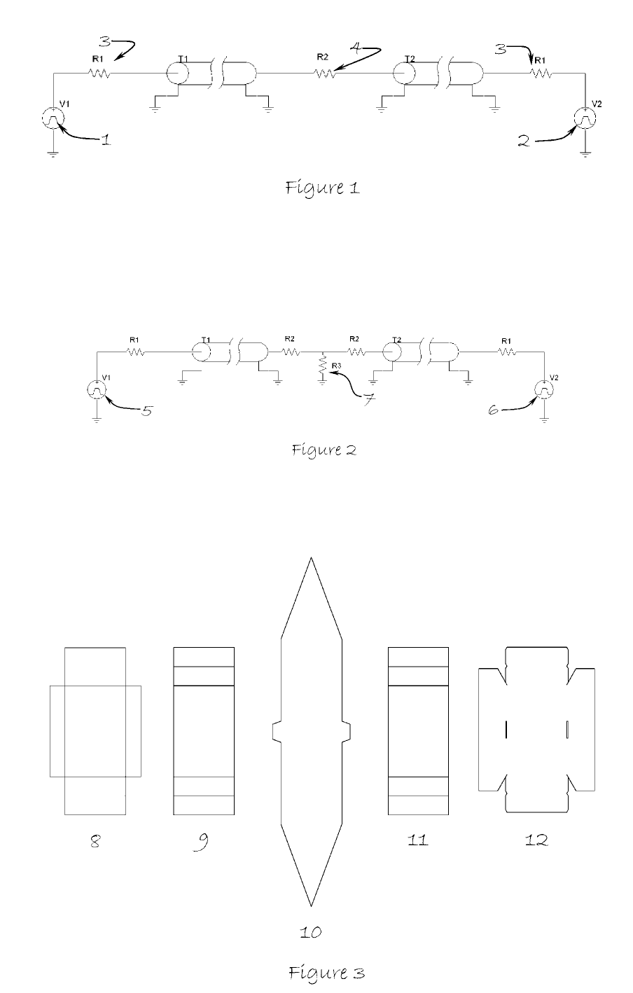

Broadband antennae are commonly energized by two matched signal generators to simultaneously couple oppositely polarized impulse signals onto the feed-points of an antenna as illustrated at 1 and 2 in FIGS. 1 and 5 and 6 in FIG. 2. Impedance mismatches at the feed point interfaces, which are typically small, and at the flare-end interfaces, which are typically large, induce reflections that rapidly deteriorate antenna performance. This is a particularly prominent problem with broadband antennas because it is difficult to design impedance interfaces that are consistent over a wide spectrum.

The signal generators shown in FIGS. 1 and 2 represent the individual transmitters that supply energy to the feed point of each antenna leaf. The serial impedances R1 at 3 in these figures represent the intrinsic impedance of each antenna leaf and are not intended to represent a specific or stand-alone component of this invention. The antenna leafs are connected in a closed circuit using two transmission lines/waveguides that are terminated in a matched impedance R2 as illustrated at 4 in FIG. 1.

Oppositely polarized pulses originate at 1, 2, 5, and 6. The signals travel across the antenna leaves, R1, and through a shielded transmission line/waveguide where the energy is cancelled at R2 and converted to heat. An additional shunt to ground, which uses resistor R3 shown at 7, provides an supplementary path to convert any remaining energy into heat. The purpose of this impedance is to dissipate any surplus energy if the generated pulses are not perfectly balanced.

Construction of the disclosed invention begins with the individual components shown in FIG. 3. These include a conductive sheet that will form the inner grounded shield layer 8, a dielectric sheet at 9 that will be placed between the inner shield 8 and the center conductive antenna circuit path 10, a single thin sheet of conductive material that will form the antenna circuit path 10, a dielectric sheet at 11 that will be placed between the antenna circuit path 10 and the outer shield 12, and a conductive sheet that will form the outer shield 12.

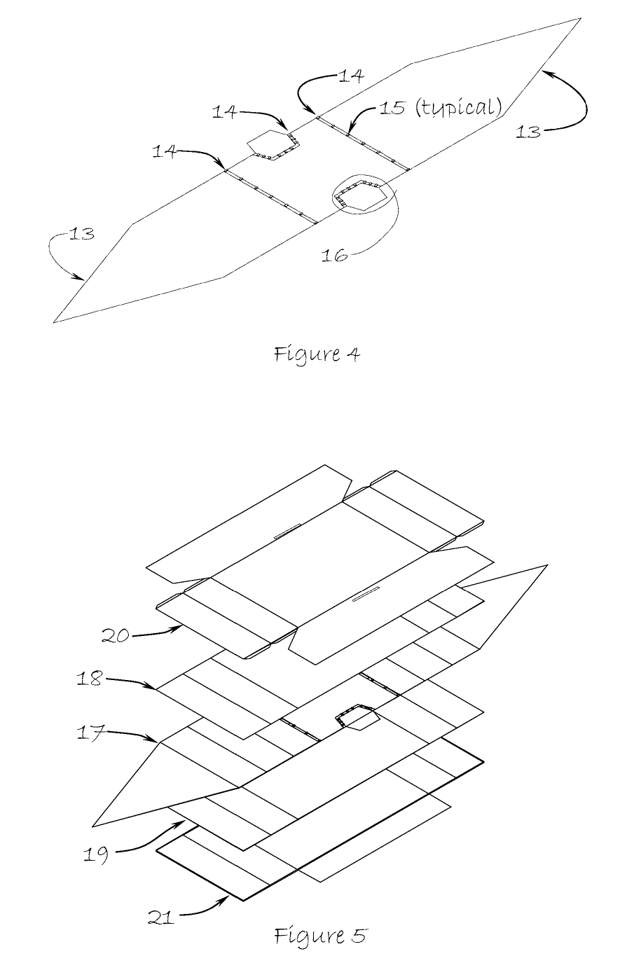

The antenna circuit path 10 shown in FIG. 3 is formed by cutting or otherwise forming a conductive material at opposite ends into the operational shape of a broad band antenna; bow-tie ends are shown by example at 13 in FIG. 4. Any number of incisions like those shown by example at 14 in FIG. 4 are subsequently etched into the antenna circuit path in the area that will comprise the energy dissipation components, shown by example as surface mount resistors at 15 in FIG. 4, to accommodate resistive tapering. A less optimal embodiment of this invention may place similar impedance tapers elsewhere on the closed-loop antenna circuit such as on the antenna leaves.

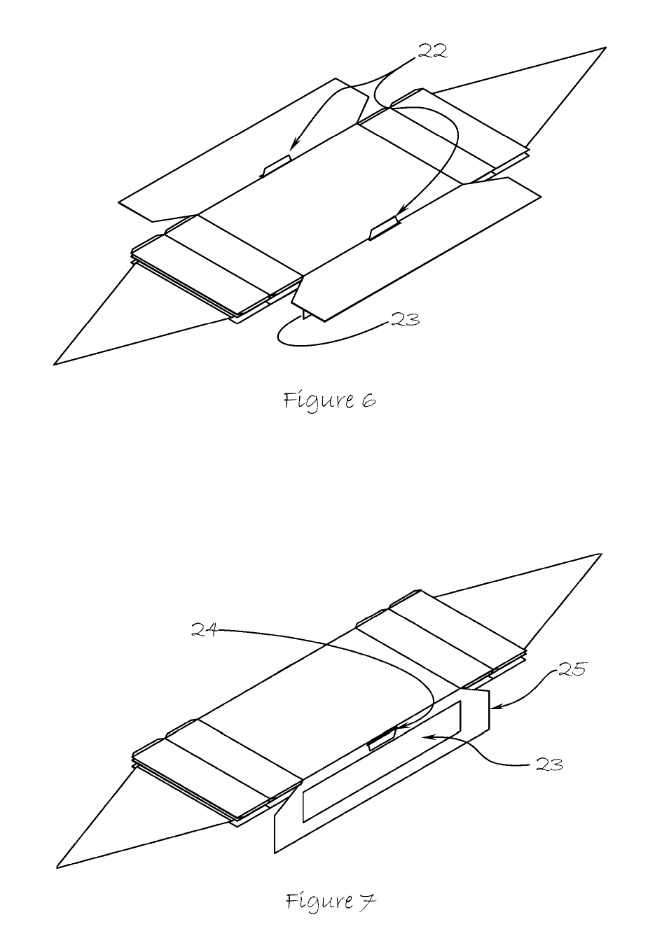

An energy dissipating path of the type shown by example at 16 may be incorporated into the antenna circuit path to provide a means to use common electrical ground to dispel any unspent energy in the antenna apparatus. This tap is electrically connected to outer conductive shields at 20 and 21 in FIG. 5 during the folding process. One intention of this invention is to electrically isolate the resulting outer back-shield from the antenna leaves to prevent side and rear lobe formation; accordingly there are no other fully conductive paths between the conductive pieces that extend into the antenna elements and those that connect to common electrical ground or to any conductive material that is on the outside of the reflector shield.

The antenna circuit loop and energy dissipation circuit assembly shown by example in FIG. 4 and at 17 in FIG. 5 is sandwiched between two layers of a flexible material shown by example at 18 and 19 that can be bent into any shape to accommodate the optimal profile of the reflector shield. The flexible material that comprises these layers may or may not have any other function than to hold the stamped antenna apparatus together during construction; or this flexible material may serve as a dielectric separator if the proper material is used. If the flexible material does not function as an impedance adjusting dielectric, then area that comprises the reflector shield is subsequently sandwiched between two flexible, injectable, or other non-conductive dielectric materials at 18 and 19 that are used to optimize antenna impedance.

Conductive flexible materials or other conductive layers, shown by example at 20 and 21 in FIG. 5, are used to electrically enclose or shield the area that comprises the reflector shield area. The tabs shown at 22 in FIG. 6 are electrically connected to the outer shield, which comprises any part of the inner plate shown at 8, 21, and 23 and the outer plate shown at 12 and 20. This illustration is not intended to restrict the scope of this invention to devices that use tabs to form an electrically conductive path between the inner and outer plates; any method can be used to accomplish the same.

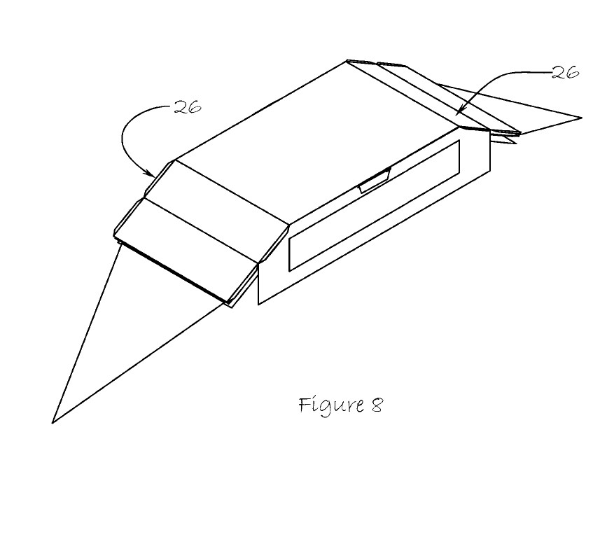

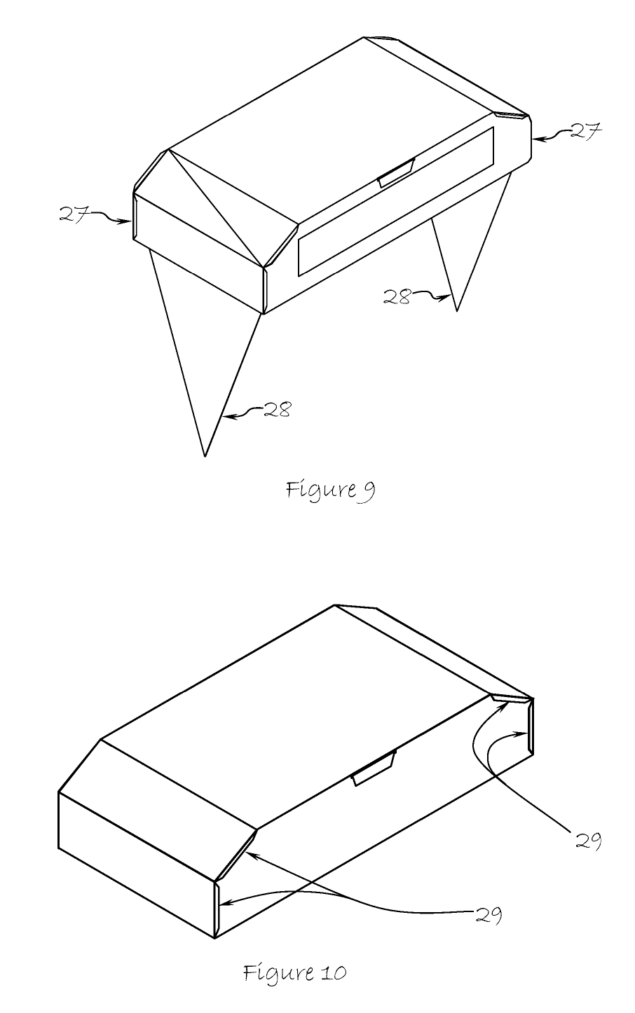

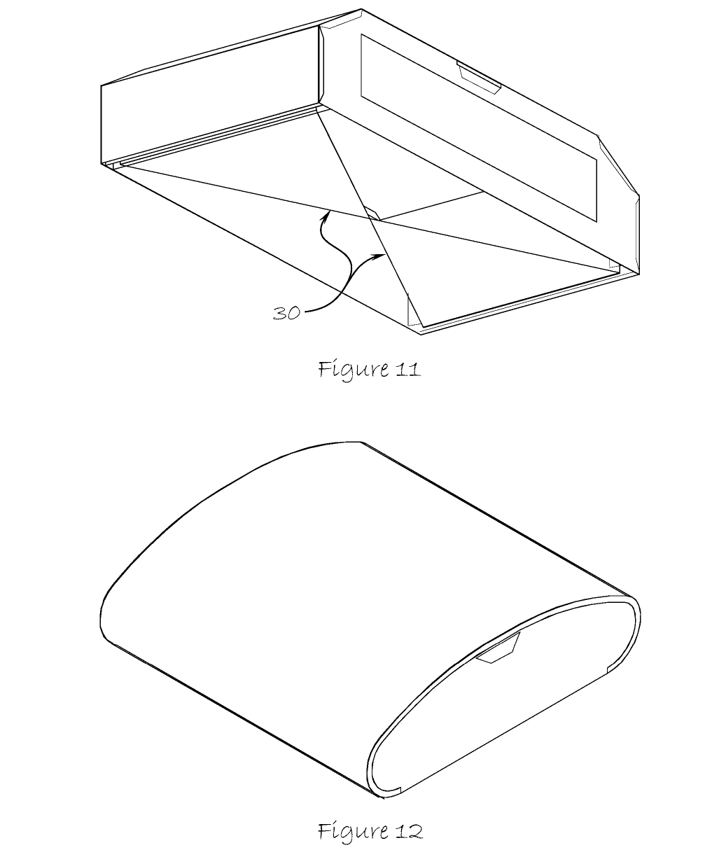

FIG. 6 illustrates how the layers can be stacked and the closed loop antenna circuit grounding flaps at 22 can be inserted into the outer shield during the first step of assembly. The inner shield is then folded down as shown in at 23 FIGS. 6 and 7. The outer shield 25 of the assembly and the closed loop antenna circuit grounding flaps 24 can be subsequently folded over and electrically bonded to the inner shield 23 as illustrated in FIG. 7. The next two folds in the sequence, shown at 26 in FIGS. 8 and 27 in FIG. 9, are used to form the back reflector shield profile of the antenna apparatus. The folding process is completed by bending the antenna elements 28 toward the center until the apparatus looks like the completed assembly shown in FIG. 10. The final position of the antenna leaves is shown at 30 in FIG. 11. Assembly taps like those shown at 27 and 29 can be used to electrically bond the side shield to the outer shield and to strengthen the antenna apparatus.

The previous example describes one method of assembling the antenna apparatus by folding the individual components into a trapezoidal shape. The apparatus can also be constructed by any combination of stamped or folded individual conductive components and by subsequently injecting dielectric materials; by using any combination of stamped or folded conductive components and depositing dielectric materials to the same or any other method of assembly of components of the type shown in FIG. 5 that embraces the spirit of this invention.

The application of thin side shields to increase antenna directivity shown in these figures is intended to show an optimal configuration of the antenna. The side shields shown in the drawings are not intended to restrict the scope of this invention to only those antenna apparatuses with side shields. Conductive tape or soldered thin conductive foil may be affixed to the inside of the side reflectors around the antenna boundaries to prevent RF leakage; however, the addition of the same or the previously noted side shield walls are not a required component of this invention. A protective non-conductive coating may or may not be applied to the outer conductive layer to strengthen the antenna apparatus.

A fully assembled embodiment of the disclosed invention is shown with a trapezoidal reflector shield in FIG. 11 and a rounded reflector shield in FIG. 12. The completed assembly shown in either figure comprises in part several important and functional components; namely the outer conductive flexible material shield (upper, lower, and sides), the inner and outer dielectric layers to adjust impedance and to isolate conductive layers, dielectric isolating materials on either side of the apparatus to isolate conductive layers, the center conductive sections that comprise the antenna circuit, and the RF dissipation impedance circuits. The antenna circuit disclosed herein may comprise any shape, impedance, wave altering patterns, surface mount components, or any combination thereof. The spirit of this invention encompasses any waveguide implementation methods that can be used to alter impedance of the antenna circuit described herein.

It is possible to embody this invention in specific antenna forms and specific smooth or jagged back-shield geometries or profiles other than those described herein without departing from the spirit of the invention. Accordingly, the embodiments described in this disclosure and in the drawings are merely illustrative and should not be considered restrictive in any way.

The spirit of this invention is largely to form a broadband antenna wherein an exposed conductive portion of the antenna comprises balanced broadband antenna leaves and the coax cable emulating portion of the antenna is formed in the vicinity of the reflector shield around the center conductor described above in part by enclosing the same between dielectric materials and an outer metallic shield. The scope of this invention is determined by the claims of this application rather than any restricting examples that comprise the preceding description. All variations and equivalents that fall within the scope of any of these claims are intended to be embraced therein.

What is claimed is:

1. Any broadband antenna and reflector assembly that comprises a center conductive antenna and an optional RF energy dissipating circuit path that may be partially enclosed or sandwiched at the reflector shield area of the antenna apparatus by air, dielectric materials, or any non-conductive materials, that are coated or enclosed by any conductive material that comprises in combination:
a. a continuous or modularly assembled center conductor that is constructed of any conductive material that comprises any geometry that optimizes broadband RF transmission in the area of the antenna apparatus that comprises the antenna leaves,
b. a continuation of the center conductor in claim 1(a) that is constructed of any conductive material that comprises any geometry in the area of the reflector shield that optimizes the performance of the reflector shield,
c. an electrical conductive gap in the center conductor in claim 1(a) that is placed between the antenna leaves at the feed-points of the antenna apparatus,
d. one or more physical separations in the center conductor in claim 1(a) that are located in the area that comprises the reflector shield to form electrically conductive gaps that are used to incorporate energy dissipating components into the antenna apparatus,
e. one or more electrically resistive materials that are used to impedance balance the antenna and are placed in the vicinity of the area that comprises the reflector shield,
f. one or more electrically reactive materials that are used to impedance balance the antenna and are placed in the vicinity of the area that comprises the reflector shield,
g. one or more electrically inductive materials that are used to impedance balance the antenna and are placed in the vicinity of the area that comprises the reflector shield,
h. any combination of the presence or absence of one or more electrically resistive, inductive, and capacitive materials that are used to impedance balance the antenna and are placed in the vicinity of the area that comprises the reflector shield,
i. one or more electrically resistive materials that are used to dissipate unspent electrical energy and are placed in the vicinity of the area that comprises the reflector shield,
j. one or more electrically reactive materials that are used to dissipate unspent electrical energy and are placed in the vicinity of the area that comprises the reflector shield,
k. one or more electrically inductive materials that are used to dissipate unspent electrical energy and are placed in the vicinity of the area that comprises the reflector shield,
l. any combination of the presence or absence of one or more electrically resistive, inductive, and capacitive materials that are used to dissipate unspent electrical energy and are placed in the vicinity of the area that comprises the reflector shield,
m. one or more electrically resistive materials that are used to dissipate unspent electrical energy and are placed in the vicinity of the area that comprises the reflector shield,
n. one or more physical separations in the center conductor in claim 1(a) that are located anywhere on the closed loop antenna circuit that are used to incorporate energy dissipating components into the antenna apparatus,
o. one or more electrically resistive materials that are used to impedance balance the antenna and are placed anywhere on the closed loop antenna circuit,
p. one or more electrically reactive materials that are used to impedance balance the antenna and are placed anywhere on the closed loop antenna circuit,
q. one or more electrically inductive materials that are used to impedance balance the antenna and are placed anywhere on the closed loop antenna circuit,
r. any combination of the presence or absence of one or more electrically resistive, inductive, and capacitive materials that are used to impedance balance the antenna and are placed anywhere on the closed loop antenna circuit,
s. one or more electrically resistive materials that are used to dissipate unspent electrical energy and are placed in anywhere on the closed loop antenna circuit,
t. one or more electrically reactive materials that are used to dissipate unspent electrical energy and are placed anywhere on the closed loop antenna circuit,
u. one or more electrically inductive materials that are used to dissipate unspent electrical energy and are placed anywhere on the closed loop antenna circuit,
v. any combination of the presence or absence of one or more electrically resistive, inductive, and capacitive materials that are used to dissipate unspent electrical energy and are placed anywhere on the closed loop antenna circuit,
w. one or more electrically resistive materials that are used to dissipate unspent electrical energy and are placed anywhere on the closed loop antenna circuit,
x. any combination of the presence or absence of one or more air, dielectric, or non-conductive materials that are used to electrically isolate any form of electromagnetic energy on any part of the center conductor in claim 1(a) from any form of electromagnetic energy that is on the common electrical ground of the antenna apparatus,
y. any combination of the presence or absence of one or more air, dielectric, or non-conductive materials that are used to electrically isolate any form of electromagnetic energy on any part of the center conductor in claim 1(a) from any form of electromagnetic energy that is on any component or device that is electrically connected to the antenna apparatus,
z. any combination of the presence or absence of conductive tape, solder, rivets, or other conductive materials that are used to prevent RF leakage around the antenna apparatus.

2. Any broadband antenna of the type in claim 1 that redirects energy from the intentional radiating antenna portion of the center conductor of the type in claim 1(a) too any resistive load that is physically located elsewhere on the antenna apparatus so that any unspent electromagnetic energy that was used to energize the antenna is dissipated at a location that does not interfere with or interferes minimally with intentional signals on the antenna and that comprises in combination:
a. any assembly of the type in claim 2 that redirects energy from the antenna elements to any impedance load that is electrically connected to the reflector shield,
b. any assembly of the type in claim 2 that redirects energy from the antenna elements to any resistive load that is electrically connected to the common electrical ground,
c. any assembly of the type claim 2 that uses any type of impedance cancellation network to dissipate any form of unspent RF energy,
d. any assembly of the type in claim 2 that uses any type of impedance cancellation network to mitigate side lobes and antenna ringing.

3. Any broadband antenna apparatus of the type in claim 1 and claim 2 that comprises in combination:
a. any conductive material that is affixed to the sides of the antenna apparatus to improve the directivity of the antenna,
b. any impedance tapered material that is affixed to the sides of the antenna apparatus to improve the directivity of the antenna,
c. any type of impedance tapered broadband antenna elements,
d. any type of broadband antenna elements that are impedance loaded at the flare-ends,
e. any type of fully conductive broadband antenna elements,
f. any type of impedance tapered reflector shield,
g. any type of fully conductive reflector shield,
h. any type of lump-impedance loaded conductive reflector shield.

4. Any broadband antenna apparatus of the type in claim 1 and claim 2 that comprises in combination:
a. any broadband antenna of any geometric shape,
b. any broadband antenna of any geometric profile,
c. any reflector back-shield of any geometric shape,
d. any reflector back-shield of any geometric profile,
e. any non-conductive protective coating or material on or around the antenna leaves,
f. any non-conductive protective coating or material on or around the reflector back-shield,
g. Any material that is used to strengthen the physical structure of any antenna of the type in claim 1.

5. Any broadband antenna apparatus of the type in claim 1 and claim 2 that comprises in combination:
a. any type of dielectric layers that are injected between conductive layers in the antenna apparatus,
b. any type of dielectric layers that are deposited onto any of the conductive layers in the antenna apparatus,
c. any type of material that is injected into the apparatus to enhance any electrical property of the device,
d. any type of material that is injected into the apparatus to enhance any physical property of the device,
e. any method of assembly.
